(19) United States
(12) Patent Application Publication
(10) Pub. No.: US 2026/0124567 A1
(43) Pub. Date: May 7, 2026

(54) AIR PURIFIER

(71) Applicant: COWAY Co., Ltd., Gongju-si (KR)

(72) Inventors: Yu Young NAM, Seoul (KR); Seung Ki KIM, Seoul (KR)

(73) Assignee: COWAY Co., Ltd., Gongju-si (KR)

(21) Appl. No.: 19/372,532

(22) Filed: Oct. 29, 2025

(30) Foreign Application Priority Data
Nov. 6, 2024 (KR) 10-2024-0156575

(51) Int. Cl. B01D 46/00; B01D 46/44; B01D 46/58

(52) U.S. Cl. CPC B01D 46/0047; B01D 46/0004; B01D 46/0005; B01D 46/0028; B01D 46/442; B01D 46/58; B01D 2265/06; B01D 2279/40

(57) ABSTRACT

An air purifier includes: a body providing an internal space; a plurality of fan units arranged to be spaced apart from each other in an up-down direction in the internal space of the body and configured to provide a blowing force for drawing air into the internal space of the body; and a plurality of filter units arranged in the up-down direction between the plurality of fan units to filter air introduced into the internal space of the body. The plurality of fan units include: a first fan unit disposed above the plurality of filter units and configured to provide a blowing force for causing air filtered by one of the plurality of filter units to flow upward; and a second fan unit disposed below the plurality of filter units and configured to provide a blowing force for causing air filtered by another one of the plurality of filter units to flow downward.

### TECHNICAL FIELD

The present disclosure relates to an air purifier.

### BACKGROUND

In general, an air purifier is a device that sucks in polluted indoor air, and purifies it into clean air by filtering out dust, odor particles, etc. contained in the air. Such an air purifier can purify indoor air by sucking in and purifying the surrounding polluted air, purifying it, and then discharging the purified clean air to the outside of the air purifier. The air purifier may include an inlet for drawing air into the interior thereof, a blower fan for providing blowing force to draw air into the inlet, a filter for filtering out dust, odor particles, and the like contained in the air drawn into the interior, and one or more outlets for discharging air filtered by the filter.

Further, a conventional air purifier may include a plurality of filters and a plurality of blower units to draw in air from different locations and discharge filtered air in different directions.

In this regard, Korean Patent Application Publication No. 10-2020-0122941 entitled "Air purifier" (Patent Document 1), filed by the applicant LG Electronics Inc., discloses an air purifier including a first blower unit for discharging air laterally and a second blower unit, for discharging air upwardly, disposed above the first blower unit. In addition, Patent Document 1 discloses that each of the first blower unit and the second blower unit includes a filter member and a fan disposed above the filter member.

However, Patent Document 1 does not disclose any mechanism by which air flows downward inside the air purifier. In other words, since the fan of each of the first blower unit and the second blower unit of Patent Document 1 is disposed above the filter member, air filtered through the filter member can only flow upward by the blowing force. Therefore, the air purifier of Patent Document 1 has the limitation that the filtered air cannot flow downward inside the air purifier, meaning that filtered air cannot be discharged toward the floor.

In addition, Korean Patent Application Publication No. 10-2018-0138248 entitled “Air purifier having bidirectional fans using a discharge flow path” (Patent Document 2), filed by the present applicant, discloses an air purifier including a filter unit for filtering air, a plurality of fans for drawing in filtered air, and a discharge flow path for discharging filtered air discharged from the plurality of fans laterally or upwardly.

However, Patent Document 2 does not disclose any mechanism by which the filtered air flows downward inside the air purifier. In other words, in the air purifier of Patent Document 2, since the plurality of fans are configured to discharge the sucked filtered air laterally or upwardly toward the discharge flow path, the filtered air can only flow upward in the discharge flow path. Therefore, the air purifier of Patent Document 2 has the limitation that the filtered air cannot flow downward inside the air purifier, meaning that the filtered air cannot be discharged toward the floor.

### Prior Art Documents

Patent document 1: Korean Patent Application Publication No. 10-2020-0122941 (Published on October 28, 2020)

Patent Document 2: Korean Patent Application Publication No. 10-2018-0138248 (Published on December 31, 2018)

### SUMMARY

In view of the above, one embodiment of the present disclosure provides an air purifier in which air filtered through a plurality of filter units can flow upward and downward.

In accordance with an aspect of the present disclosure, there is provided an air purifier including: a body providing an internal space; a plurality of fan units arranged to be spaced apart from each other in an up-down direction in the internal space of the body and configured to provide a blowing force for drawing air into the internal space of the body; and a plurality of filter units arranged in the up-down direction between the plurality of fan units to filter air introduced into the internal space of the body, wherein the plurality of fan units include: a first fan unit disposed above the plurality of filter units and configured to provide a blowing force for causing air filtered by one of the plurality of filter units to flow upward; and a second fan unit disposed below the plurality of filter units and configured to provide a blowing force for causing air filtered by another one of the plurality of filter units to flow downward.

Further, the body may include: an upper inlet through which air is introduced; a lower inlet through which air is introduced, the lower inlet being positioned below the upper inlet; an upper outlet for discharging air, the upper outlet being positioned above the upper inlet; and a lower outlet for discharging air, the lower outlet being positioned below the lower inlet. The plurality of filter units may include: a first filter unit that filters air introduced through the upper inlet; and a second filter unit that filters air introduced through the lower inlet. The upper outlet may be disposed above the first filter unit to discharge air filtered by the first filter unit, and the lower outlet may be disposed below the second filter unit to discharge air filtered by the second filter section.

Further, the air purifier may further include a partition unit disposed between the first filter unit and the second filter unit to partition the internal space of the body.

Further, the partition unit may include: a first support part disposed below the first filter unit to be movable in the up-down direction; a second support part disposed above the second filter unit to be movable in the up-down direction; and an elastic part providing an elastic force to move one of the first support part and the second support part away from the other of the first support part and the second support part.

Further, the body may include: a first body part in which the upper inlet, the lower inlet, and the lower outlet are formed and which provides the internal space; and a second body part disposed on top of the first body part to cover the internal space and in which the upper outlet is formed. The upper outlet may be open upward to discharge filtered air in an upward direction, and the lower outlet may be formed on a lower side surface of the first body part to discharge filtered air laterally downward.

Further, the air purifier may further include: a cover part for opening and closing the upper outlet; and a lifting and lowering unit that supports the cover part and is arranged to be movable in the up-down direction with respect to the second body part so that the cover part opens and closes the upper outlet.

Further, each of the first filter unit and the second filter unit may include a plurality of filter members that are connected at their sides to be rotatable relative to each other.

Further, the air purifier may further include a sterilization unit that sterilizes the air filtered by the plurality of filter units.

Further, the first fan unit may include: a first fan housing having a first intake port through which filtered air is drawn in; a first fan that is at least partially accommodated in the first fan housing and rotates about a rotational axis extending in the up-down direction; and a first fan driving unit configured to provide a driving force to rotate the first fan, the second fan unit may include: a second fan housing having a second intake port through which filtered air is drawn in; a second fan that is at least partially accommodated in the second fan housing and rotates about a rotational axis extending in the up-down direction; and a second fan driving unit configured to provide a driving force to rotate the second fan, the sterilization unit may be provided as a plurality of sterilization units, and the plurality of sterilization units may include: a first sterilization unit disposed in the first intake port to sterilize filtered air introduced into the first intake port, and a second sterilization unit disposed in the second intake port to sterilize filtered air introduced into the second intake port.

Further, the first fan may be disposed between the plurality of filter units and the first fan driving part, and the second fan may be disposed between the plurality of filter units and the second fan driving part.

Further, the first sterilization unit may include: a first sterilization part for sterilizing filtered air; a first sterilization body disposed between the plurality of filter units and the first fan housing and having a communication opening to allow filtered air to flow into the first intake port; and a first sterilization support extending from a central portion of the first sterilization body toward the first fan to support the first sterilization part so that the first sterilization part is placed in the first intake port , the second sterilization unit may include: a second sterilization part for sterilizing filtered air; a second sterilization body disposed between the plurality of filter units and the second fan housing and having a communication port to allow filtered air to flow into the second intake port; and a second sterilization support extending from a central portion of the second sterilization body toward the second fan to support the second sterilization part so that the second sterilization part is placed in the second intake port.

Further, the air purifier may further include a controller for controlling the first fan unit and the second fan unit, wherein the controller may independently control the first fan unit and the second fan unit such that a blowing force of one of the first fan unit and the second fan unit is greater than a blowing force of the other of the first fan unit and the second fan unit, or such that the blowing forces of the first fan unit and the second fan unit are equal.

Further, the air purifier may further include a sensor unit that detects a concentration of first foreign substances and a concentration of second foreign substances that are larger than the first foreign substances. The controller may control the second fan unit and the first fan unit such that the blowing force of the second fan unit is greater than the blowing force of the first fan unit when the concentration of the second foreign substances detected by the sensor unit is greater than the concentration of the first foreign substances, and control the second fan unit and the first fan unit such that the blowing force of the first fan unit is greater than the blowing force of the second fan unit when the concentration of the first foreign substances detected by the sensor unit is greater than the concentration of the second foreign substances.

According to one embodiment of the present disclosure, the plurality of filter units are arranged between the plurality of fan units, so that air filtered can flow upward and downward inside the body of the air purifier.

Further, according to one embodiment of the present disclosure, the upper inlet and the lower inlet are located between the upper outlet and the lower outlet, so that interference between the inflow of air into the body and the outflow of filtered air from the body can be prevented.

Furthermore, according to one embodiment of the present disclosure, the upper inlet and the lower inlet are arranged at the central portion of the body, so that a centralized flow path can be formed, thereby improving the purification performance.

In addition, according to one embodiment of the present disclosure, the filtered air can be discharged laterally downward through the lower outlet, which makes foreign substances on the floor lifted and suspended in the air.

Further, according to one embodiment of the present disclosure, the partition unit can prevent the filtered air flowing in the first space and the filtered air flowing in the second space from mixing with each other.

In addition, according to one embodiment of the present disclosure, the filtered air can be sterilized by the sterilization unit inside the body and discharged outside the body.

### BRIEF DESCRIPTION OF THE DRAWINGS

FIG. 1 is a perspective view of an air purifier according to one embodiment of the present disclosure.

FIG. 2 is a side view of the air purifier of FIG. 1.

FIG. 3 is a cross-sectional view of the air purifier of FIG. 1 taken along line III-III.

FIG. 4 is an exploded perspective view of the air purifier of FIG. 1.

FIG. 5 is a side view showing a cover part of the air purifier of FIG. 2 in a lowered state.

FIG. 6 is an enlarged view of a first fan unit of the air purifier shown in FIG. 3.

FIG. 7 is an enlarged view of a second fan unit of the air purifier shown in FIG. 3.

FIG. 8 is a cross-sectional view of the air purifier of FIG. 1 taken along line VIII-VIII.

FIG. 9 is an enlarged view of a partition unit of the air purifier shown in FIG. 3.

### DETAILED DESCRIPTION

Hereinafter, specific embodiments for implementing a spirit of the present disclosure will be described in detail with reference to the drawings.

In describing the present disclosure, detailed descriptions of known configurations or functions may be omitted to clarify the present disclosure.

When an element is referred to as being 'connected' to, 'supplied' to, or 'transferred' to, another element, it should be understood that the element may be directly connected to, supported by, supplied to, or transferred to another element, but that other elements may exist in the middle.

The terms used in the present disclosure are only used for describing specific embodiments, and are not intended to limit the present disclosure. Singular expressions include plural expressions unless the context clearly indicates otherwise.

Further, in the present disclosure, it is to be noted that expressions, such as the upper side, the lower side, and the side surface, are described based on the illustration of drawings, but may be modified if directions of corresponding objects are changed. For the same reasons, some components are exaggerated, omitted, or schematically illustrated in the accompanying drawings, and the size of each component does not fully reflect the actual size.

Further, terms including ordinal numbers, such as first and second, may be used for describing various elements, but the corresponding elements are not limited by these terms. These terms are only used for the purpose of distinguishing one element from another element.

In the present specification, it is to be understood that the terms such as “including” are intended to indicate the existence of the certain features, areas, integers, steps, actions, elements, combinations, and/or groups thereof disclosed in the specification, and are not intended to preclude the possibility that one or more other certain features, areas, integers, steps, actions, elements, combinations, and/or groups thereof may exist or may be added.

Hereinafter, an air purifier 1 according to one embodiment of the present disclosure will be described with reference to the drawings.

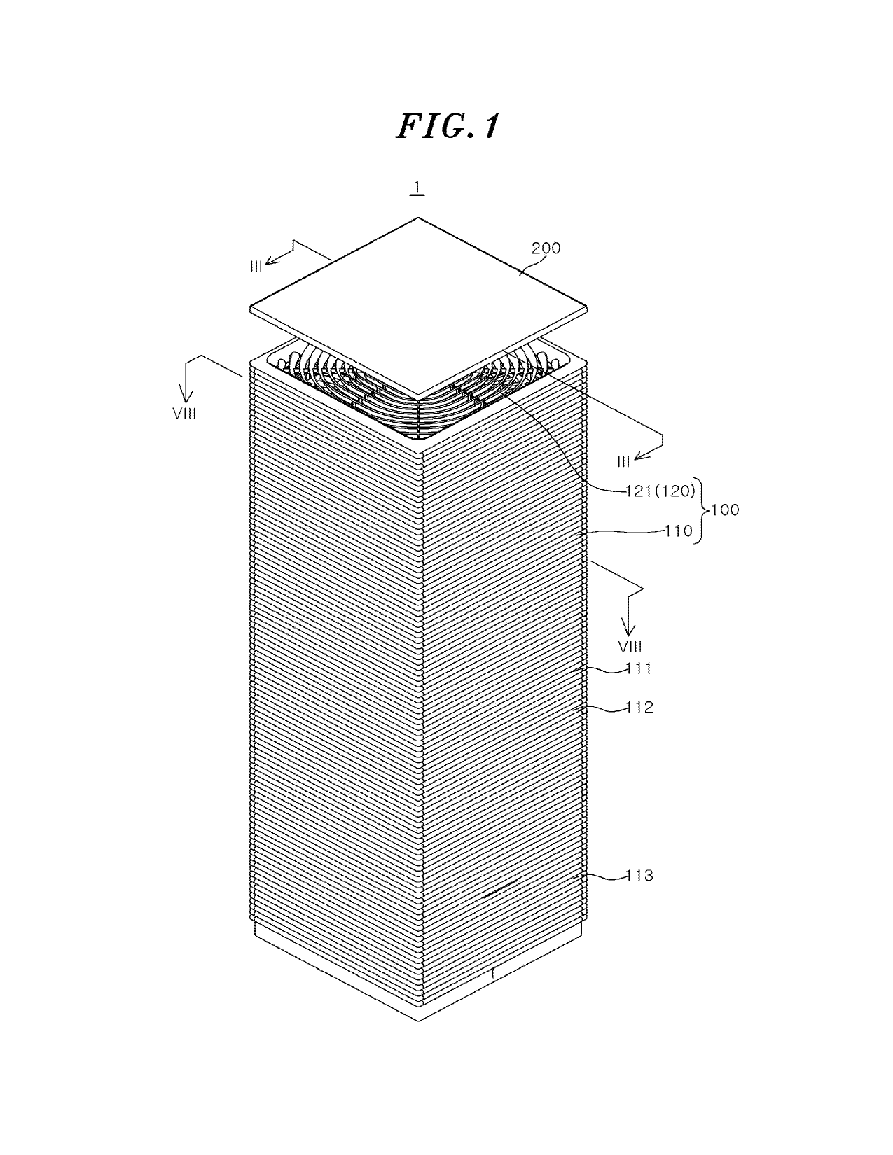

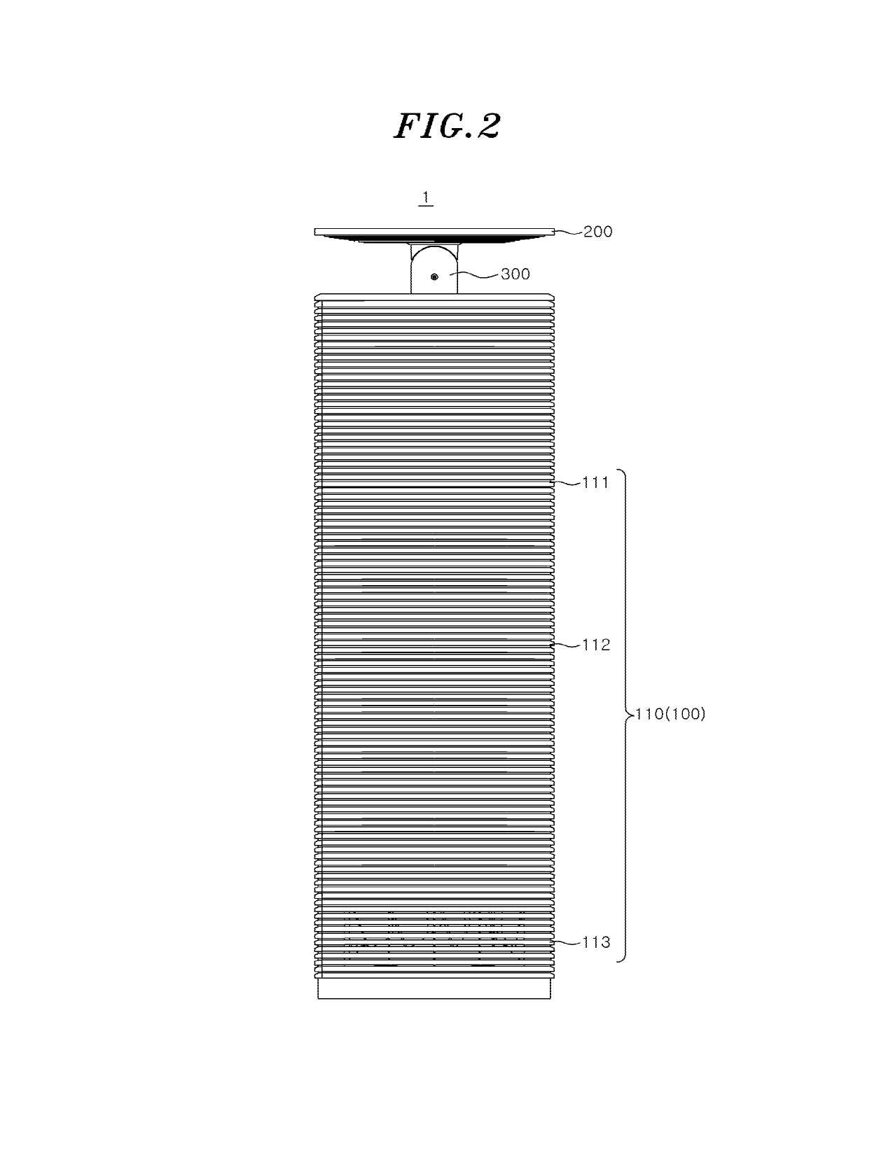

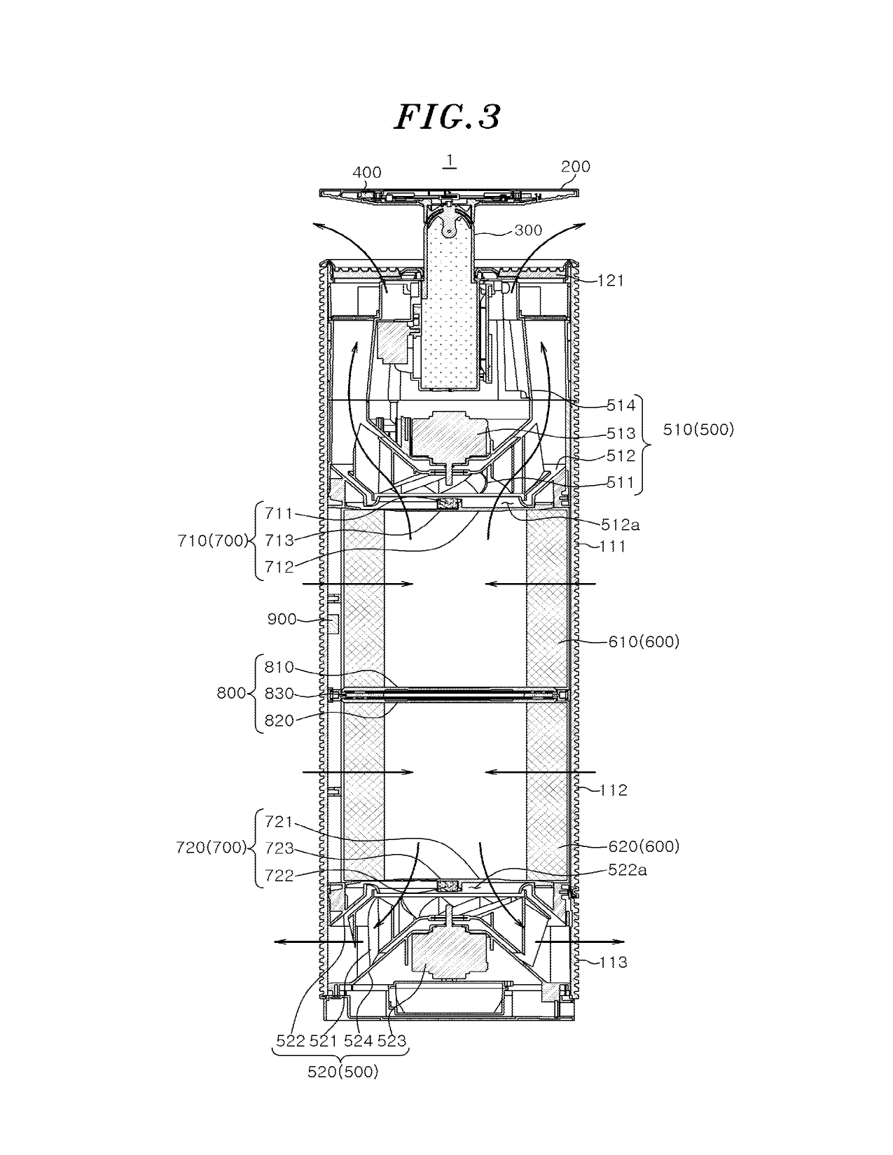

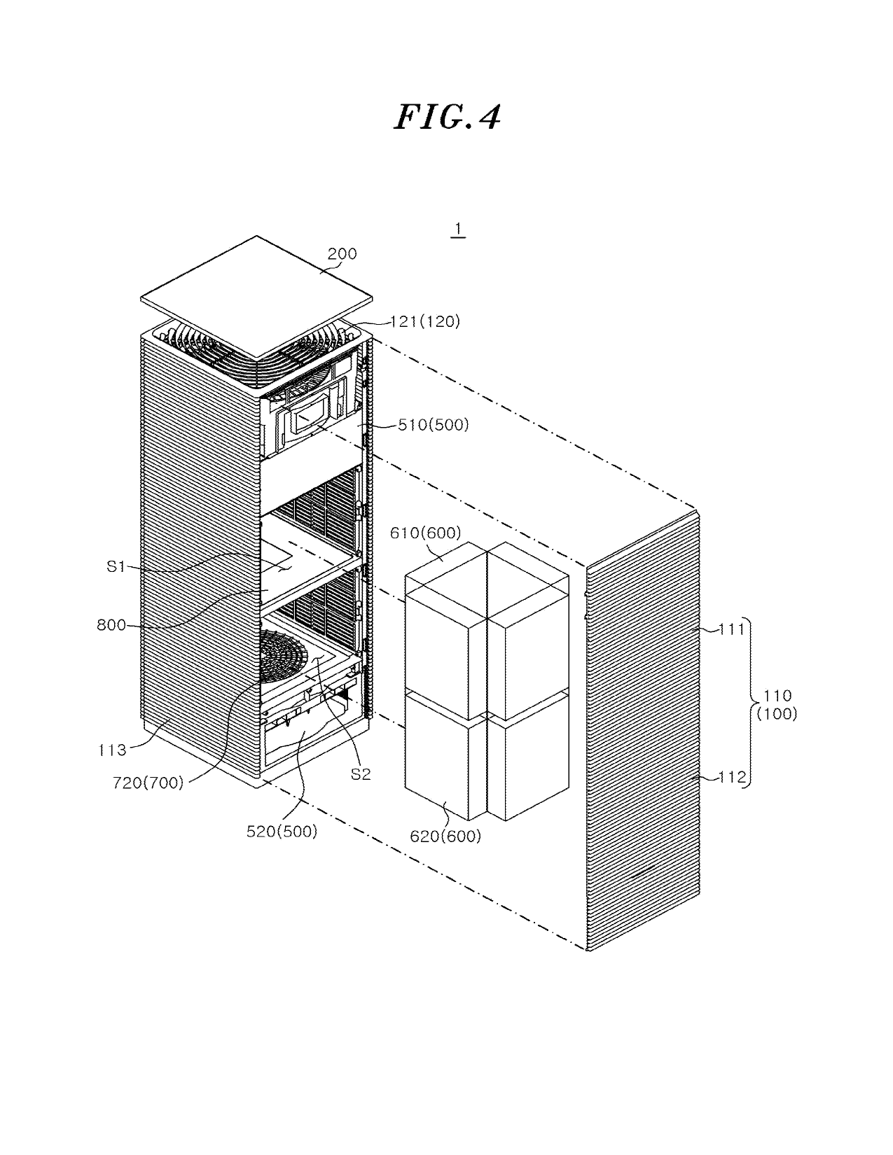

Referring to FIGS. 1 to 4, the air purifier 1 can purify polluted air into clean air by filtering dust, odor particles, and the like of air introduced into the interior of the air purifier 1. The air purifier 1 can draw external air into the interior, and discharge clean air purified therein to the outside. The air purifier 1 may include a body 100, a cover part 200, a lifting and lowering unit 300, a controller 400, a fan unit 500, a filter unit 600, a sterilization unit 700, a partition unit 800, and a sensor unit 900.

The body 100 may provide an internal space for accommodating a plurality of fan units 500 and a plurality of filter units 600. The body 100 may serve as a housing that provides an exterior appearance of the air purifier 1. The internal space of the body 100 may include a first space S1 in which a first filter unit 610 of the plurality of filter units 600 is disposed and a second space S2 in which a second filter unit 620 of the plurality of filter units 600 is disposed. In addition, the body 100 may include a first body part 110 and a second body part 120.

The first body part 110 may be formed to extend in an up-down direction to provide the internal space. The first body part 110 may support the second body part 120. The first body part 110 may be provided with an upper inlet 111, a lower inlet 112, and a lower outlet 113.

The upper inlet 111 may be formed on a side surface of the first body part 110 to allow air to be drawn in. The upper inlet 111 can be in communication with the first space S1. In other words, air can flow into the first space S1 through the upper inlet 111.

The lower inlet 112 may be formed on a side surface of the first body part 110 to allow air to be drawn in, and may be disposed below the upper inlet 111. In addition, the lower inlet 112 can be in communication with the second space S2. In other words, air can flow into the second space S2 through the lower inlet 112. The upper inlet 111 and the lower inlet 112 may be located at the central portion of the body 100, or may be arranged closer to the central portion of the body 100 than the lower outlet 113 and an upper outlet 121, which will be described later.

The lower outlet 113 can discharge air filtered by the second filter unit 620. The lower outlet 113 may be disposed below the lower inlet 112 and the second filter unit 620. The lower outlet 113 may be formed on a lower side surface of the first body part 110 to discharge the filtered air laterally downward.

The second body part 120 may be disposed on top of the first body part 110 to cover the internal space of the first body part 110. An upper outlet 121 may be formed in the second body part 120. The upper outlet 121 may discharge air filtered by the first filter unit 610. The upper outlet 121 may be disposed above the upper inlet 111 and the first filter unit 610. This upper outlet 121 may be open upward to discharge the filtered air in an upward direction.

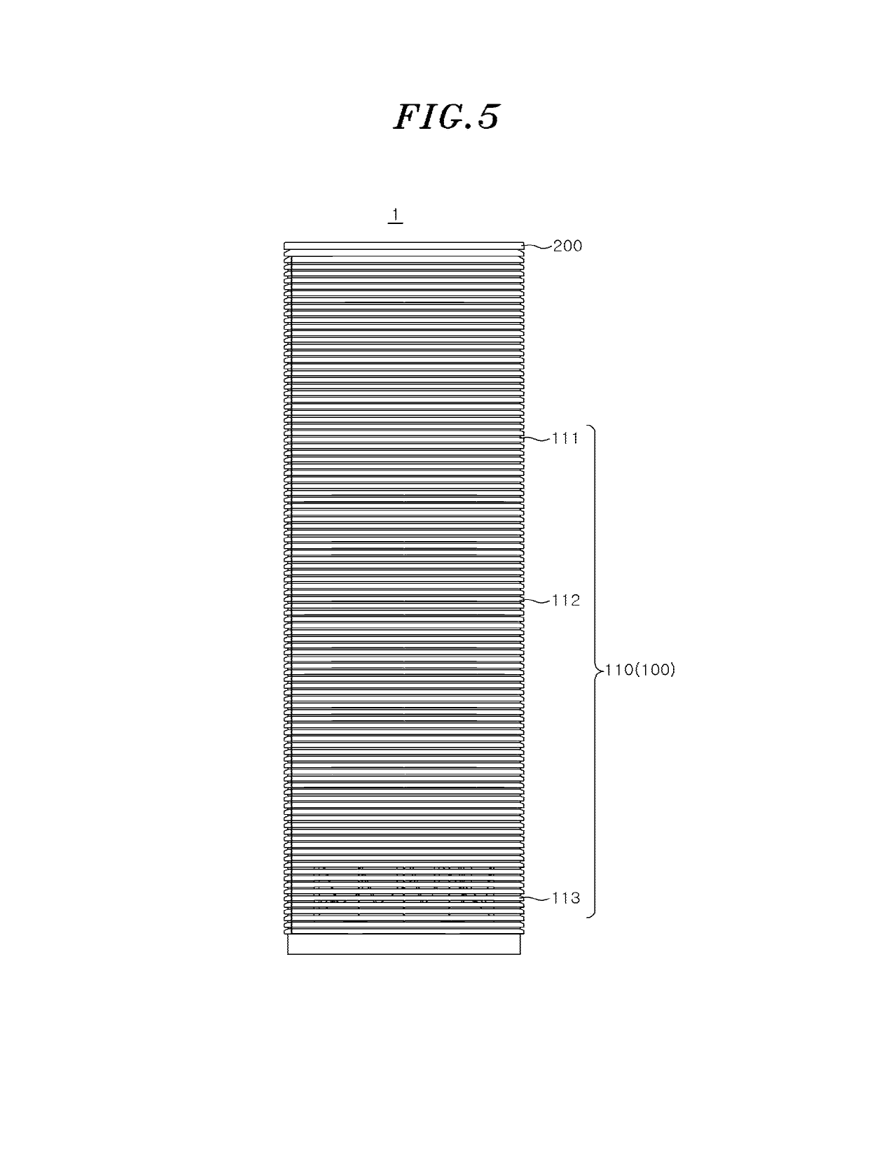

Referring further to FIG. 5, the cover part 200 may be arranged to be movable in the up-down direction with respect to the body 100 to open and close the upper outlet 121. The cover part 200 can be moved toward the second body part 120 to close the upper outlet 121. When closing the upper outlet 121, the cover part 200 can come into contact with an upper surface of the second body part 120. In addition, the cover part 200 can be moved away from the second body part 120 to open the upper outlet 121.

The lifting and lowering unit 300 can support the cover part 200. In addition, the lifting and lowering unit 300 can be arranged to be movable in the up-down direction with respect to the second body part 120 so that the cover part 200 can open and close the upper outlet 121. In other words, the lifting and lowering unit 300 can be moved downward with respect to the second body part 120 so that the cover part 200 closes the upper outlet 121. The lifting and lowering unit 300 can be arranged inside the body 100 when the cover part 200 closes the upper outlet 121. In addition, the lifting and lowering unit 300 can be moved upward with respect to the second body part 120 so that the cover part 200 opens the upper outlet 121. The upper part of the lifting and lowering unit 300 can be exposed to the outside when the cover part 200 opens the upper outlet 121. The lifting and lowering unit 300 may extend through a central portion of the second body part 120 to be movable in the up-and-down direction. Further, the lower part of the lifting and lowering unit 300 may be accommodated in a first driving unit accommodation part 514, which will be described later.

The controller 400 can independently control the first fan unit 510 and the second fan unit 520. In other words, the controller 400 can control the first fan unit 510 and the second fan unit 520 such that a blowing force of one of them is greater than a blowing force of the other. When the blowing force of the first fan unit 510 is made to be greater than the blowing force of the second fan unit 520 by the controller 400, the amount of air introduced through the upper inlet 111 can be greater than the amount of air introduced through the lower inlet 112. Conversely, when the blowing force of the second fan unit 520 is made to be greater than the blowing force of the first fan unit 510 by the controller 400, the amount of air introduced through the lower inlet 112 can be greater than the amount of air introduced through the upper inlet 111. In addition, the controller 400 can control the first fan unit 510 and the second fan unit 520 such that the blowing forces of the first fan unit 510 and the second fan unit 520 are equal. In this case, the amount of air introduced through the lower inlet 112 and the amount of air introduced through the upper inlet 111 can be equal. Further, the controller 400 can adjust the blowing forces of the first fan unit 510 and the second fan unit 520 based on the concentration of foreign substances detected by the sensor unit 900.

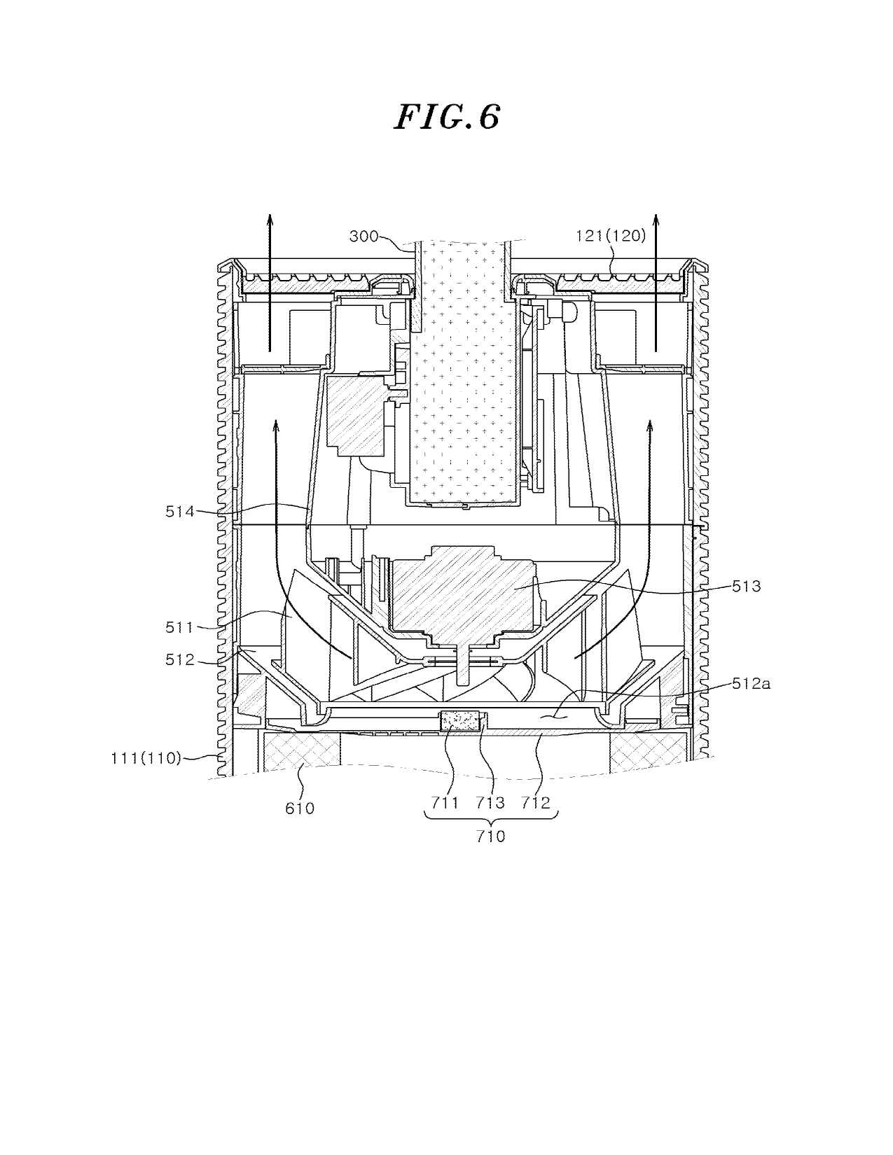

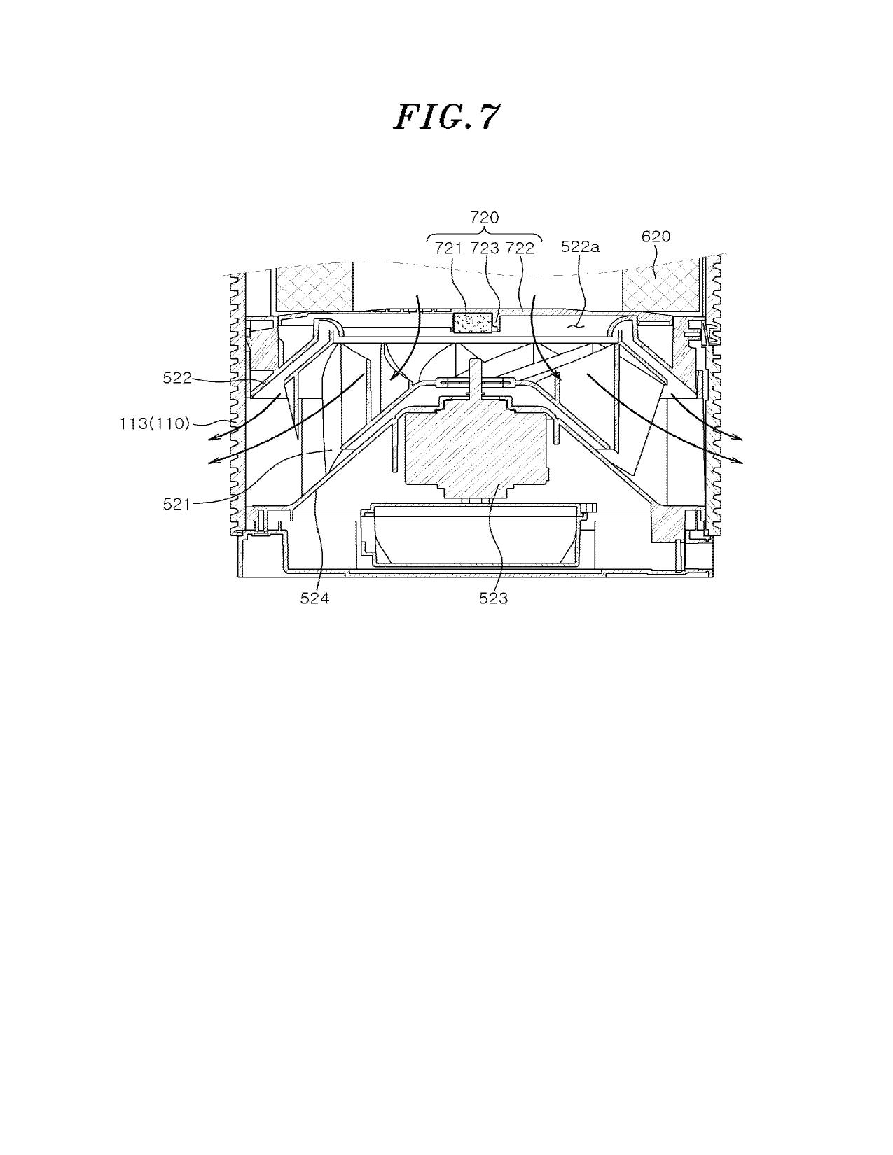

Referring further to FIGS. 6 and 7, the fan unit 500 may be arranged in the internal space of the body 100 to provide a blowing force for drawing air into the internal space of the body 100. In addition, the fan unit 500 may be provided as a plurality of fan units arranged to be spaced apart from each other in the up-down direction in the internal space of the body 100. The plurality of fan units 500 may include a first fan unit 510 and a second fan unit 520.

The first fan unit 510 may be disposed above the plurality of filter units 600 to provide a blowing force for causing air filtered by one of the plurality of filter units 600 to flow upward. In other words, the first fan unit 510 may be disposed in the first space S1 to be positioned above the first filter unit 610 to cause air filtered by the first filter unit 610 to flow upward. The first fan unit 510 may include a first fan 511, a first fan housing 512, a first fan driving unit 513, and a first driving unit accommodation part 514.

The first fan 511 may be at least partially accommodated in the first fan housing 512 and can rotate about a rotation axis extending in the up-down direction. The first fan 511 may be disposed between the plurality of filter units 600 and the first fan driving unit 513. By the first fan 511, air filtered by the first filter unit 610 can flow toward the first fan housing 512 from the first space S1. The first fan 511 may be formed so that its vertical length increases as the horizontal distance from the rotation axis increases.

The first fan housing 512 can accommodate at least a portion of the first fan 511. In addition, the first fan housing 512 may be formed with a first intake port 512a through which filtered air is drawn in. In other words, air filtered by the first filter unit 610 can be drawn into the first intake port 512a. The first intake port 512a may be positioned below the first fan 511. The horizontal length of the first intake port 512a may be smaller than the horizontal length of the first fan 511.

The first fan driving unit 513 can provide driving force to rotate the first fan 511. For example, the first fan driving unit 513 may be a motor. The first fan driving unit 513 may be positioned above the first fan 511. The first fan driving unit 513 may be accommodated in the first driving unit accommodation part 514. In addition, the first fan driving unit 513 may be positioned below the lifting and lowering unit 300.

The first driving unit accommodation part 514 can provide a space for accommodating the first fan driving unit 513. The first driving unit accommodation part 514 may be positioned above the first fan 511. In addition, the first driving unit accommodation part 514 may be formed to extend in the up-down direction to guide the filtered air passing through the first intake port 512a to flow toward the upper outlet 121. In other words, a flow path through which the filtered air flows may be formed between the first driving unit accommodation part 514 and the first body part 110. Through the flow path, the filtered air can flow toward the upper outlet 121. Further, the first driving unit accommodation part 514 may accommodate at least a portion of the lifting and lowering unit 300. In addition, the lower end of the first driving unit accommodation part 514 may be positioned below the upper end of the first fan 511. In other words, the lower end of the first driving unit accommodation part 514 may be located inside the first fan 511.

The second fan unit 520 may be disposed below the plurality of filter units 600 to provide a blowing force for causing air filtered by another one of the plurality of filter units 600 to flow downward. In other words, the second fan unit 520 may be disposed in the second space S2 to be positioned below the second filter unit 620 to cause air filtered by the second filter unit 620 to flow downward. The second fan unit 520 may include a second fan 521, a second fan housing 522, a second fan driving unit 523, and a second driving unit accommodation part 524.

The second fan 521 may be at least partially accommodated in the second fan housing 522 and can rotate about a rotation axis extending in the up-down direction. By the second fan 521, air filtered by the second filter unit 620 can flow toward the second fan housing 522 from the second space S2. The second fan 521 may be formed so that its vertical length increases as the horizontal distance from the rotation axis increases.

The second fan housing 522 can accommodate at least a portion of the second fan 521. In addition, the second fan housing 522 may be formed with a second intake port 522a through which filtered air is drawn in. In other words, air filtered by the second filter unit 620 can be drawn into the second intake port 522a. The second intake port 522a may be positioned above the second fan 521. The horizontal length of the second intake port 522a may be smaller than the horizontal length of the second fan 521.

The second fan driving unit 523 can provide driving force to rotate the second fan 521. For example, the second fan driving unit 523 may be a motor. The second fan driving unit 523 may be positioned below the second fan 521. The second fan driving unit 523 may be accommodated in the second driving unit accommodation part 524.

The second driving unit accommodation part 524 can provide a space for accommodating the second fan driving unit 523. The second driving unit accommodation part 524 may be positioned below the second fan 521. Further, the second driving unit accommodation part 524 can guide the filtered air passing through the second intake port 522a to flow toward the lower outlet 113. In addition, the horizontal width of the second driving unit accommodation part 524 may increase as it extends downward. By means of the second driving unit accommodation part 524 with such configuration, the filtered air can flow laterally downward along the outer surface of the second driving unit accommodation part 524 and be discharged laterally downward through the lower outlet 113. In addition, the upper end of the second driving unit accommodation part 524 may be positioned above the lower end of the second fan 521. In other words, the upper end of the second driving unit accommodation part 524 may be located inside the second fan 521.

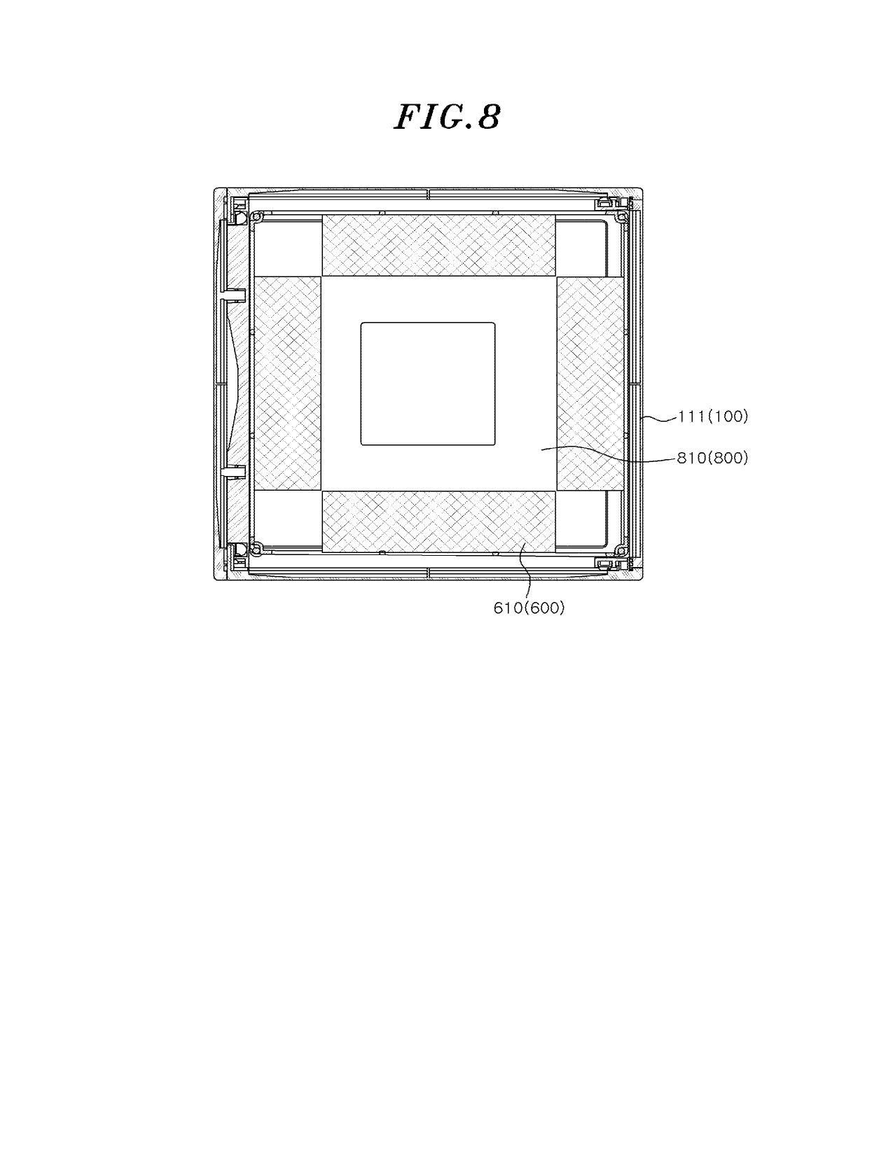

Referring further to FIG. 8, the filter unit 600 can filter air introduced into the internal space of the body 100. The filter unit 600 may be provided as a plurality of filter units arranged in the up-down direction between the plurality of fan units 500 in the internal space of the body 100. In addition, each of the plurality of filter units 600 may include a plurality of filter members that are connected at their sides to be rotatable relative to each other. For example, the plurality of filter units 600 may be foldable square filters. The plurality of filter units 600 may include a first filter unit 610 and a second filter unit 620.

The first filter unit 610 can filter air introduced through the upper inlet 111. The first filter unit 610 may be disposed in the first space S1. In addition, the first filter unit 610 may be positioned between the first fan unit 510 and the second filter unit 620.

The second filter unit 620 may be disposed below the first filter unit 610 and can filter air introduced through the lower inlet 112. The second filter unit 620 may be disposed in the second space S2. The second filter unit 620 may be positioned between the first filter unit 610 and the second fan unit 520.

The sterilization unit 700 can sterilize air filtered by the plurality of filter units 600. For example, the sterilization unit 700 can eliminate bacteria, viruses, mold, and the like that flow along with the filtered air. The sterilization unit 700 may be provided as a plurality of sterilization units arranged spaced apart from each other in the up-down direction in the internal space of the body 100. The plurality of sterilization units 700 may include a first sterilization unit 710 and a second sterilization unit 720.

The first sterilization unit 710 is disposed in the first intake port 512a and can sterilize filtered air introduced into the first intake port 512a. In other words, the first sterilization unit 710 may be positioned between the first fan 511 and the first filter unit 610. The first sterilization unit 710 may include a first sterilization part 711, a first sterilization body 712, and a first sterilization support 713.

The first sterilization part 711 is positioned at the first intake port 512a and can sterilize filtered air drawn into the first intake port 512a. For example, the first sterilization part 711 may include an ultraviolet filter, a photocatalytic filter, an electrostatic precipitator filter, a plasma filter, an antibacterial filter, or the like.

The first sterilization body 712 may be disposed between the plurality of filter units 600 and the first fan housing 512, and may be formed with a communication opening to allow filtered air to flow into the first intake port 512a. In other words, the first sterilization body 712 may be formed to extend horizontally to be disposed between the first filter unit 610 and the first fan housing 512. The filtered air can pass through the first sterilization body 712 and flow toward the first intake port 512a.

The first sterilization support 713 can support the first sterilization part 711. The first sterilization support 713 may extend from a central portion of the first sterilization body 712 toward the first fan 511 so that the first sterilization part 711 is placed in the first intake port 512a.

The second sterilization unit 720 is disposed in the second intake port 522a and can sterilize the filtered air introduced into the second intake port 522a. In other words, the second sterilization unit 720 may be positioned between the second fan 521 and the second filter unit 620. The second sterilization unit 720 may include a second sterilization part 721, a second sterilization body 722, and a second sterilization support 723.

The second sterilization part 721 is positioned at the second intake port 522a and can sterilize filtered air drawn into the second intake port 522a. For example, the second sterilization part 721 may include an ultraviolet filter, a photocatalytic filter, an electrostatic precipitator filter, a plasma filter, an antibacterial filter, or the like.

The second sterilization body 722 may be disposed between the plurality of filter units 600 and the second fan housing 522, and may be formed with a communication port to allow filtered air to flow into the second intake port 512a. In other words, the second sterilization body 722 may be formed to extend horizontally to be disposed between the second filter unit 620 and the second fan housing 522. The filtered air can pass through the second sterilization body 722 and flow toward the second intake port 522a.

The second sterilization support 723 can support the second sterilization part 721. The second sterilization support 723 may extend from a central portion of the second sterilization body 722 toward the second fan 521 so that the second sterilization part 721 is placed in the second intake port 522a.

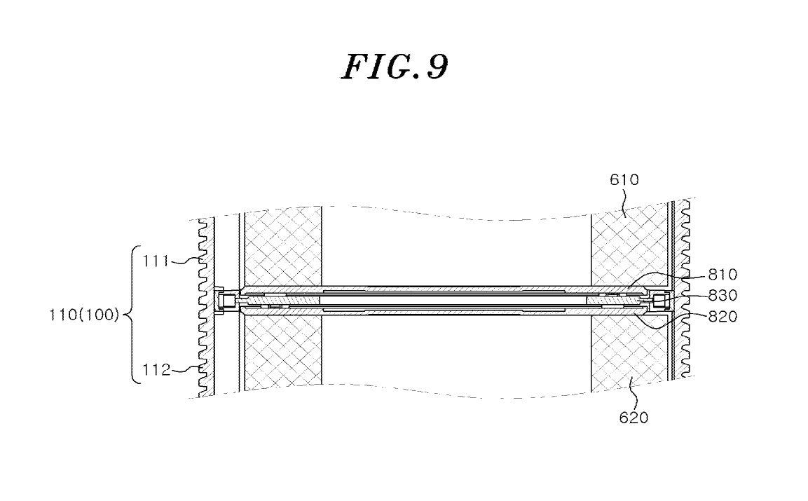

Referring further to FIG. 9, the partition unit 800 may be disposed between the first filter unit 610 and the second filter unit 620 to partition the internal space of the body 100. In other words, the partition unit 800 can separate the first space S1 from the second space S2. The partition unit 800 can prevent air introduced through the upper inlet 111 and air introduced through the lower inlet 112 from mixing with each other. The partition unit 800 may include a first support part 810, a second support part 820, and an elastic part 830.

The first support part 810 can support the first filter unit 610. The first support part 810 may be disposed below the first filter unit 610 to be movable in the up-down direction. The first support part 810 can press the first filter unit 610 upward. By the first support part 810, the upper end of the first filter unit 610 can be moved to be close to or to be in close contact with the first sterilization body 712 or the first fan housing 512.

The second support part 820 can support the second filter unit 620. The second support part 820 may be disposed above the second filter unit 620 to be movable in the up-down direction. The second support part 820 can press the second filter unit 620 downward. By the second support part 820, the lower end of the second filter unit 620 can be moved to be close to or to be in close contact with the second sterilization body 722 or the second fan housing 522.

The elastic part 830 can provide an elastic force to move one of the first support part 810 and the second support part 820 away from the other of the first support part 810 and the second support part 820. In other words, the elastic part 830 can provide an elastic force to move the first support part 810 upward. By means of the elastic part 830, the first support part 810 can press the first filter member 610 upward. In addition, the elastic part 830 can provide an elastic force to move the second support part 820 downward. By means of the elastic part 830, the second support part 820 can press the second filter member 620 downward.

The sensor unit 900 can detect the concentration of foreign substances. For example, the foreign substances may include dust, dirt, bacteria, hair, etc. The sensor unit 900 may be supported on the body 100 to detect foreign substances flowing into the interior of the body 100. In other words, the sensor unit 900 can detect the concentration of foreign substances introduced through the upper inlet 111 and the lower inlet 112. For example, the sensor unit 900 may be placed at each of the upper inlet 111 and the lower inlet 112. In addition, the sensor unit 900 can detect the concentration of first foreign substances and the concentration of second foreign substances that are larger than the first foreign substances. When the concentration of the second foreign substances detected by the sensor unit 900 is greater than the concentration of the first foreign substances, the controller 400 can control the second fan unit 520 and the first fan unit 510 such that the blowing force of the second fan unit 520 is greater than the blowing force of the first fan unit 510. Further, when the concentration of the first foreign substances detected by the sensor unit 900 is greater than the concentration of the second foreign substances, the controller 400 can control the second fan unit 520 and the first fan unit 510 such that the blowing force of the first fan unit 510 is greater than the blowing force of the second fan unit 520.

Hereinafter, the operation and effects of the air purifier 1 according to one embodiment of the present disclosure will be described.

According to one embodiment of the present disclosure, the first fan unit 510, the first sterilization unit 710, the first filter unit 610, the partition unit 800, the second filter unit 620, the second sterilization unit 720, and the second fan unit 520 can be sequentially arranged from top to bottom in the body 100 of the air purifier 1. In other words, the plurality of fan units 500, the plurality of filter units 600, and the plurality of sterilization units 700 can be arranged in a mirrored layout with respect to the partition unit 800.

In addition, due to the blowing force of the first fan unit 510, external air can be drawn in through the upper inlet 111 and filtered by the first filter unit 610. The air filtered by the first filter unit 610 can flow upward, be sterilized by the first sterilization unit 710, and be drawn into the first fan unit 510. The filtered air drawn into the first fan unit 510 can be guided upward and discharged upward through the upper outlet 121.

Further, due to the blowing force of the second fan unit 520, external air can be drawn in through the lower inlet 112 and filtered by the second filter unit 620. The air filtered by the second filter unit 620 can flow downward, be sterilized by the second sterilization unit 720, and be drawn into the second fan unit 520. The filtered air drawn into the second fan unit 520 can be guided downward and discharged laterally downward through the lower outlet 113.

Since the plurality of filter units 600 of the air purifier 1 can be arranged between the plurality of fan units 500, the filtered air inside the body 100 can flow upward and downward.

In addition, since the upper inlet 111 and the lower inlet 112 are arranged between the upper outlet 121 and the lower outlet 113, the flow of air introduced into the body 100 and the flow of filtered air discharged from the body 100 do not interfere with each other.

Further, since the upper inlet 111 and the lower inlet 112 can be arranged at the central portion of the body 100, a centralized flow path can be formed, thereby improving the purification performance.

Furthermore, the filtered air can be discharged laterally downward through the lower outlet 113, which makes foreign substances on the floor lifted and suspended in the air.

In addition, by the partition unit 800, the filtered air flowing in the first space S1 and the filtered air flowing in the second space S2 can be prevented from mixing with each other.

Further, the filtered air can be sterilized inside the body 100 by the sterilization unit 700 and discharged to the outside of the body 100.

Furthermore, since the upper end of the first filter unit 610 can be in contact with the first sterilization unit 710 and the lower end can be in contact with the first support part 810, air introduced through the upper inlet 111 can be prevented from being drawn into the first fan unit 510 without being filtered by the first filter unit 610.

In addition, since the lower end of the second filter unit 620 can be in contact with the second sterilization unit 720 and the upper end can be in contact with the second support part 820, air introduced through the lower inlet 112 can be prevented from being drawn into the second fan unit 520 without being filtered by the second filter unit 620.

Although the embodiments of the present disclosure have been described above as specific examples, these are merely illustrative, and not intended to limit the present disclosure. The present disclosure should be interpreted as having the broadest scope in accordance with the technical ideas disclosed in the present specification. Those skilled in the art may combine/substitute the disclosed embodiments to implement patterns not explicitly described, and such implementations still fall within the scope of the present disclosure. In addition, those skilled in the art may readily make changes or modifications to the disclosed embodiments based on the present specification, and it is evident that such changes or modifications are also within the scope of the claims of the present disclosure.

What is claimed is:

1. An air purifier comprising:
a body providing an internal space;
a plurality of fan units arranged to be spaced apart from each other in an up-down direction in the internal space of the body and configured to provide a blowing force for drawing air into the internal space of the body; and
a plurality of filter units arranged in the up-down direction between the plurality of fan units to filter air introduced into the internal space of the body,
wherein the plurality of fan units include:
a first fan unit disposed above the plurality of filter units and configured to provide a blowing force for causing air filtered by one of the plurality of filter units to flow upward; and
a second fan unit disposed below the plurality of filter units and configured to provide a blowing force for causing air filtered by another one of the plurality of filter units to flow downward.

2. The air purifier of claim 1, wherein the body includes:
an upper inlet through which air is introduced;
a lower inlet through which air is introduced, the lower inlet being positioned below the upper inlet;
an upper outlet for discharging air, the upper outlet being positioned above the upper inlet; and
a lower outlet for discharging air, the lower outlet being positioned below the lower inlet,
wherein the plurality of filter units include:
a first filter unit that filters air introduced through the upper inlet; and
a second filter unit that filters air introduced through the lower inlet,
wherein the upper outlet is disposed above the first filter unit to discharge air filtered by the first filter unit, and
wherein the lower outlet is disposed below the second filter unit to discharge air filtered by the second filter section.

3. The air purifier of claim 2, further comprising a partition unit disposed between the first filter unit and the second filter unit to partition the internal space of the body.

4. The air purifier of claim 3, wherein the partition unit includes:
a first support part disposed below the first filter unit to be movable in the up-down direction;
a second support part disposed above the second filter unit to be movable in the up-down direction; and
an elastic part providing an elastic force to move one of the first support part and the second support part away from the other of the first support part and the second support part.

5. The air purifier of claim 2, wherein the body includes:
a first body part in which the upper inlet, the lower inlet, and the lower outlet are formed and which provides the internal space; and
a second body part disposed on top of the first body part to cover the internal space and in which the upper outlet is formed,
wherein the upper outlet is open upward to discharge filtered air in an upward direction, and
wherein the lower outlet is formed on a lower side surface of the first body part to discharge filtered air laterally downward.

6. The air purifier of claim 5, further comprising:
a cover part for opening and closing the upper outlet; and
a lifting and lowering unit that supports the cover part and is arranged to be movable in the up-down direction with respect to the second body part so that the cover part opens and closes the upper outlet.

7. The air purifier of claim 2, wherein each of the first filter unit and the second filter unit includes a plurality of filter members that are connected at their sides to be rotatable relative to each other.

8. The air purifier of claim 1, further comprising a sterilization unit that sterilizes the air filtered by the plurality of filter units.

9. The air purifier of claim 8, wherein the first fan unit includes:
a first fan housing having a first intake port through which filtered air is drawn in;
a first fan that is at least partially accommodated in the first fan housing and rotates about a rotational axis extending in the up-down direction; and
a first fan driving unit configured to provide a driving force to rotate the first fan,
wherein the second fan unit includes:
a second fan housing having a second intake port through which filtered air is drawn in;
a second fan that is at least partially accommodated in the second fan housing and rotates about a rotational axis extending in the up-down direction; and
a second fan driving unit configured to provide a driving force to rotate the second fan,
wherein the sterilization unit is provided as a plurality of sterilization units, and
wherein the plurality of sterilization units include:
a first sterilization unit disposed in the first intake port to sterilize filtered air introduced into the first intake port, and
a second sterilization unit disposed in the second intake port to sterilize filtered air introduced into the second intake port.

10. The air purifier of claim 9, wherein the first fan is disposed between the plurality of filter units and the first fan driving part, and
the second fan is disposed between the plurality of filter units and the second fan driving part.

11. The air purifier of claim 9, wherein the first sterilization unit includes:
a first sterilization part for sterilizing filtered air;
a first sterilization body disposed between the plurality of filter units and the first fan housing and having a communication opening to allow filtered air to flow into the first intake port; and
a first sterilization support extending from a central portion of the first sterilization body toward the first fan to support the first sterilization part so that the first sterilization part is placed in the first intake port,
wherein the second sterilization unit includes:
a second sterilization part for sterilizing filtered air;
a second sterilization body disposed between the plurality of filter units and the second fan housing and having a communication port to allow filtered air to flow into the second intake port; and
a second sterilization support extending from a central portion of the second sterilization body toward the second fan to support the second sterilization part so that the second sterilization part is placed in the second intake port.

12. The air purifier of claim 1, further comprising a controller for controlling the first fan unit and the second fan unit,
wherein the controller independently controls the first fan unit and the second fan unit such that a blowing force of one of the first fan unit and the second fan unit is greater than a blowing force of the other of the first fan unit and the second fan unit, or such that the blowing forces of the first fan unit and the second fan unit are equal.

13. The air purifier of claim 12, further comprising a sensor unit that detects a concentration of first foreign substances and a concentration of second foreign substances that are larger than the first foreign substances,
wherein the controller controls the second fan unit and the first fan unit such that the blowing force of the second fan unit is greater than the blowing force of the first fan unit when the concentration of the second foreign substances detected by the sensor unit is greater than the concentration of the first foreign substances, and controls the second fan unit and the first fan unit such that the blowing force of the first fan unit is greater than the blowing force of the second fan unit when the concentration of the first foreign substances detected by the sensor unit is greater than the concentration of the second foreign substances.
